(19) United States
(12) Patent Application Publication
(10) Pub. No.: US 2009/0121978 A1
(43) Pub. Date: May 14, 2009

(54) Plasma display device and driving method thereof

(76) Inventors: Hak-Cheol Yang, Suwon-si (KR); Joon-Yeon Kim, Suwon-si (KR); Yon-Goo Park, Suwon-si (KR); Jong-Ki Choi, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/289,976

(22) Filed: Nov. 7, 2008

(30) Foreign Application Priority Data
Nov. 9, 2007 (KR) 10-2007-0114283

(51) Int. Cl. G09G 3/28

(52) U.S. Cl. 345/60

(57) ABSTRACT

A plasma display device includes a plurality of scan lines for selecting a plurality of discharge cells and extending in a row direction. The plasma display device sequentially applies a scan pulse to the plurality of scan lines. The plasma display device calculates a data similarity ratio of two adjacent scan lines by using subfield data of each discharge cell disposed on the two adjacent scan lines among the plurality of scan lines, and overlaps the scan pulses applied to the two adjacent scan lines when the data similarity ratio of two adjacent scan lines is greater than a predetermined ratio.

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on 9 Nov. 2007 and there duly assigned Serial No. 10-2007-0114283.

### BACKGROUND OF THE INVENTION

1. Field of the Invention

The present invention relates to a plasma display device and to a driving method therefor, and more particularly, to a plasma display device that reduces an address period without reducing a width of scan pulses and a driving method therefor.

2. Description of the Related Art

A plasma display device is display device using a plasma display panel for displaying variable visual characters and/or images, such as moving images corresponding to a video signal, by using plasma generated by the phenomenon of gas discharge.

The plasma display device performs by dividing a frame into a plurality of subfields with each of the subfields having a weight value, and displays a grayscale according to the combination of weight values of the plurality of subfields, and an operation of displaying an image is performed among the plurality of subfields. During an address period of the subfields, a scan pulse is sequentially applied to a plurality of scan electrodes, and an address pulse is selectively applied to a plurality of address electrodes when the scan pulse is applied to each scan electrode, therefore, either a light emitting cell or a non-light emitting cell may be selected. Here, an address discharge occurs in a cell formed by the scan electrode applied with the scan pulse and the address electrode applied with the address pulse. Each light emitting cell performs a sustain discharge during a sustain period of each subfield and thus images are displayed.

A plasma display panel includes a front substrate, a rear substrate, pairs of sustain electrodes, i.e., X and Y electrodes, disposed on an inner surface of the front substrate, a front dielectric layer covering the sustain electrode pairs, an address electrode formed on an inner surface of the rear substrate in a direction crossing the direction in which the sustain electrode pairs are disposed, a plurality of partition walls interposed between the front and rear substrates, and red, blue and green phosphor layers coated in discharge cell defined by the partition walls.

The structure of the plasma display panel as described above has an electrical signal supplied to a Y electrode and an address electrode to select a discharge cell. The plasma display panel also has an electrical signal alternately supplied to the sustain discharge electrodes. Then, a surface discharge occurs on the inner surface of the front substrate, thereby generating ultraviolet rays which impinge upon the phosphor layer. Visible light is emitted from the phosphor layer in the selected discharge cell, and a still image or a moving image is displayed as a result.

Because of the limitation of the address period, the width of the scan pulses is reduced in the plasma display device having a large amount of scan electrodes, and thus the address discharge may become unstable. Further, when the address discharge is unstable, the sustain discharge may not be maintained and thus the images may be abnormally displayed.

The information disclosed above in this Background section is only for enhancement of understanding of the background of the invention and therefore it may contain information that does not form the prior art that is already known in this country to a person of ordinary skill in the art.

### SUMMARY OF THE INVENTION

It is therefore one object of the present invention to provide an improved plasma display device in order to overcome the disadvantage of the instability of the address discharge, and a driving method therefor.

It is another object of the present invention to provide a plasma display device that reduces an address period without reducing a width of scan pulses and produces a stable sustain discharge, and a driving method therefor.

One exemplary embodiment of the present invention provides a plasma display device including a plurality of scan lines, a driver, and a controller. The plurality of scan lines define a plurality of discharge cells, and extend in a row direction. The driver sequentially applies a scan pulse to the plurality of scan lines during an address period. The controller divides one frame into a plurality of subfields with each of the subfields including an address period, respectively; determines a degree of overlap of the scan pulses applied to two adjacent scan lines according to a data similarity ratio of the two adjacent scan lines among the plurality of scan lines using image data input during the one frame; and outputs an overlap control signal according to the degree of overlap to the driver. At this time, the driver overlaps or does not overlap the scan pulses applied to the two adjacent scan lines according to the overlap control signal.

Another exemplary embodiment of the present invention discloses a method for driving a plasma display device, the method includes forming a plurality of scan lines for selecting a plurality of discharge cells, and sequentially applying a scan pulse to a plurality of scan lines. According to this method, a frame is divided into a plurality of subfields; subfield data indicating light emitting/non-light emitting states of respective discharge cells is generated by using the image data; a data similarity ratio of two adjacent scan lines among the plurality of scan lines is respectively calculated by using the subfield data; a degree of overlap of the scan pulses applied to the two adjacent scan lines is determined according to the data similarity ratio; and the scan pulses applied to the two adjacent scan lines are selectively overlapped according to the determined degree of overlap.

Still another exemplary embodiment of the present invention discloses a method of driving a plasma display device including a plurality of scan electrodes and a plurality of address electrodes crossing the plurality of scan electrodes, and a plurality of discharge cells formed by the plurality of scan electrodes and the plurality of address electrodes. According to the method, during an address period, an overlap control signal is sequentially outputted according to a data similarity ratio of two adjacent scan lines among the plurality of scan lines, and a scan pulse is sequentially applied to the plurality of scan lines according to the overlap control signal. At this time, the overlap control signal includes a first level signal and a second level signal, and the scan pulses applied to the two adjacent scan lines are overlapped according to the first level signal and the scan pulses applied to the two adjacent scan lines are not overlapped according to the second level signal.

Still another exemplary embodiment of the present invention discloses a plasma display device for driving by dividing a frame into a plurality of subfields each having a weight value. The plasma display device includes a plurality of scan lines, a driver, and a controller. The plurality of scan lines include a plurality of discharge cells, and extend in a row direction. The driver sequentially applies a scan pulse to the plurality of scan lines during the address period. The controller controls the driver, so that scan pulses respectively applied to adjacent first and second scan lines among the plurality of subfields, are overlapped in a first subfield among the plurality of subfields, and scan pulses respectively applied to the adjacent first and second scan lines, are not overlapped in a second subfield among the plurality of subfields. In this embodiment, a weight value of the first subfield is greater than a weight value of the second subfield.

According to an exemplary embodiment of the present invention, the address period may be reduced without reducing the width of the scan pulses and luminance of an image may be increased when the period reduced from the address period is allocated to the sustain period.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram illustrating a plasma display device constructed as an exemplary embodiment of the present invention;

FIG. 2 is a table illustrating subfields constructed as an exemplary embodiment of the present invention;

FIG. 3 is a block diagram illustrating a controller constructed as an exemplary embodiment of the present invention;

FIG. 4 is a flowchart illustrating an operation of the controller constructed as an exemplary embodiment of the present invention;

FIG. 5 is a group of waveforms illustrating a group of driving waveforms of the plasma display device constructed as an exemplary embodiment of the present invention;

FIG. 6 is a schematic circuit diagram illustrating a scan electrode driver constructed as an exemplary embodiment of the present invention; and

FIG. 7 is a schematic circuit diagram illustrating a schematic circuit of a pair of transistors included in the scan integrated circuit as shown in FIG. 6.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, if something is described to “include constituent elements”, it may further include other constituent elements unless it is described that it does not include other constituent elements.

In the present invention, a wall charge is a charge formed close to each electrode on the wall of a cell, for example a dielectric layer. Although the wall charges do not actually touch the electrodes, the wall charges will be described as being “formed” or “accumulated” on the electrode. Also, a wall voltage is a potential difference formed at the wall of a cell by wall charges. A weak discharge is a discharge that is weaker than a sustain discharge in a sustain period and an address discharge in an address period.

The plasma display device and a driving method therefor according to the exemplary embodiment of the present invention will now be described in detail.

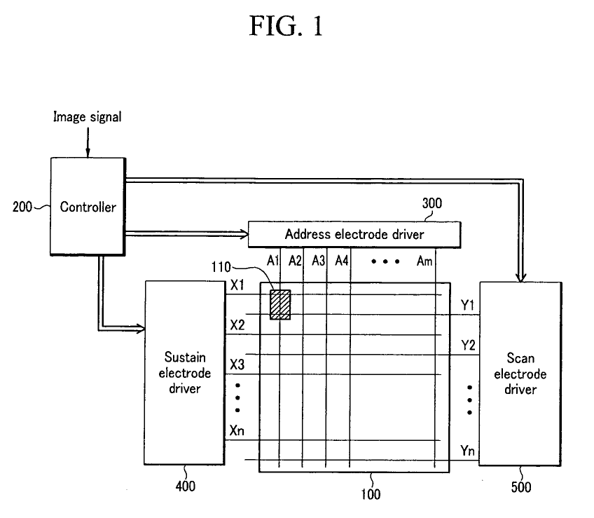

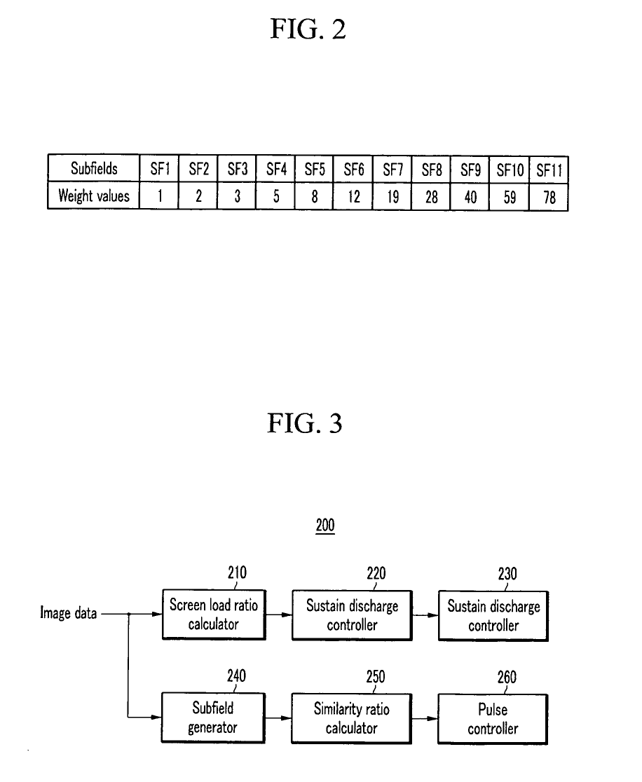

FIG. 1 is a schematic diagram illustrating a plasma display device constructed as an exemplary embodiment of the present invention, and FIG. 2 is a table illustrating subfields constructed as an exemplary embodiment of the present invention.

As shown in FIG. 1, a plasma display device according to an exemplary embodiment of the present invention includes a plasma display panel 100, a controller 200, an address electrode driver 300, a sustain electrode driver 400, and a scan electrode driver 500.

Plasma display panel 100 includes a plurality of address electrodes A1-Am (referred to as “A electrodes” hereinafter) extending in a column direction, and a plurality of sustain electrodes X1-Xn (referred to as “X electrodes” hereinafter) and a plurality of scan electrodes Y1-Yn (referred to as Y electrodes hereinafter) extending in a row direction, in pairs. The X electrodes X1-Xn are formed to correspond to the respective Y electrodes Y1-Yn, and the X electrodes X1-Xn and the Y electrodes Y1-Yn perform a display operation during a sustain period in order to display an image.

The Y electrodes Y1-Yn and the X electrodes X1-Xn are disposed to cross the A electrodes A1-Am. At this time, a plurality of scan lines are defined by the Y electrodes Y1-Yn applied with a scan pulse during an address period, and an address line is defined by the A electrodes A1-Am applied with an address pulse during an address period.

A discharge space at each crossing area of the A electrodes A1-Am and the X and Y electrodes X1-Xn and Y1-Yn forms discharge cells 110.

The structure of PDP 100 shows one example, and a panel with a different structure to which driving waveforms described herein can be applied can also be applicable in the present invention. As shown in FIG. 2, controller 200 drives a frame by dividing it into a plurality of subfields with each having a weight value. Each subfield includes the address period and a sustain period. As shown in FIG. 2, one frame includes eleven subfields, i.e., SF1-SF11, respectively having weight values 1, 2, 3, 5, 8, 12, 19, 28, 40, 59, and 78, and grayscales may be displayed from the grayscale 0 to the grayscale 255.

Controller 200 generates subfield data indicating respective light emitting/non-light emitting states of the plurality of discharge cells 110 in the plurality of subfields (SF1-SF11 in FIG. 2), and outputs driving control signals according to the subfield data to address electrode driver 300.

Here, controller 200 calculates a data similarity ratio of two adjacent scan lines among the plurality of scan lines using the subfield data. Controller 200 determines a degree of overlap of the scan pulses applied corresponding to two scan lines according to the data similarity ratio, and outputs driving control signals according to the degree of overlap to scan electrode driver 500.

Further, controller 200 calculates a screen load ratio using image data input during one frame, determines a total number of sustain pulses allocated to one frame using the screen load ratio, and allocates the total number of sustain pulses to each subfield (SF1-SF11 in FIG. 2). Controller 200 outputs driving control signal according to sustain pulses allocated to each subfield (SF1-SF11 in FIG. 2) to at least one driver among sustain electrode driver 400 and scan electrode driver 500.

Address electrode driver 300 receives the driving control signal from controller 200 and applies a driving voltage to the A electrodes, and sustain electrode driver 400 receives the driving control signal from controller 200 and applies a driving voltage to the X electrodes. Scan electrode driver 500 receives the driving control signal from controller 200 and applies a driving voltage to the Y electrodes.

In detail, during the address period, in order to select a light emitting cell and a non-light emitting cell among the plurality of discharge cells in each subfield, scan electrode driver 500 applies the scan pulses to the Y electrodes Y1-Yn in an order where the Y electrodes Y1-Yn are sequentially selected, and address electrode driver 300 selectively applies the address pulses to the A electrodes A1-Am according to the subfield data when the scan pulses are applied to the respective Y electrodes. Here, it is assumed that the scan pulse is sequentially applied to the Y electrodes Y1-Yn, and scan electrode driver 500 may apply the scan pulse, that is overlapped with the scan pulse applied to the Y electrode (i.e., Y1), to the Y electrode (i.e., Y2) or may apply the scan pulse, that is not overlapped with the scan pulse applied to the Y electrode (i.e., Y1), to the Y electrode (i.e., Y2).

During the sustain period, sustain electrode driver 400 and scan electrode driver 500 alternately apply the sustain pulses to the X electrodes X1-Xn and the Y electrodes Y1-Yn a number of times corresponding to a weight value of the corresponding subfield. Then, sustain discharges occur in the light emitting cell.

Next, a method for determining the degree of overlap of the scan pulse applied to the two scan lines in the address period will be described in detail with reference to FIGS. 3 to 5.

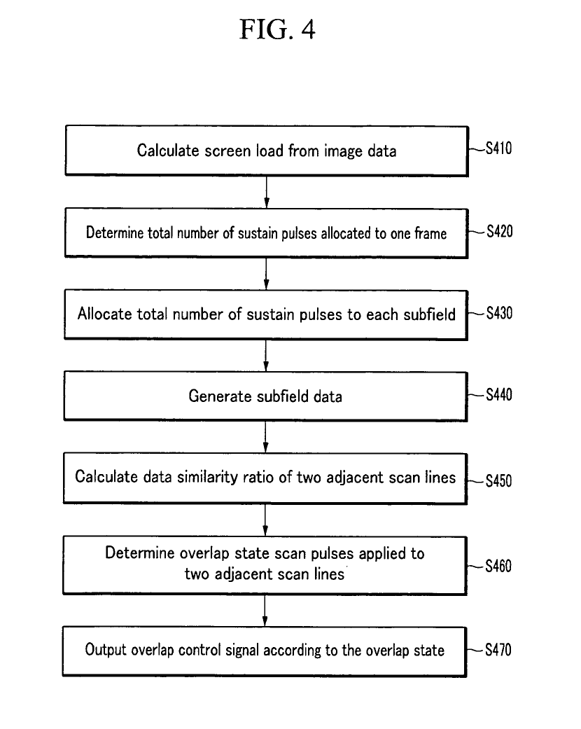

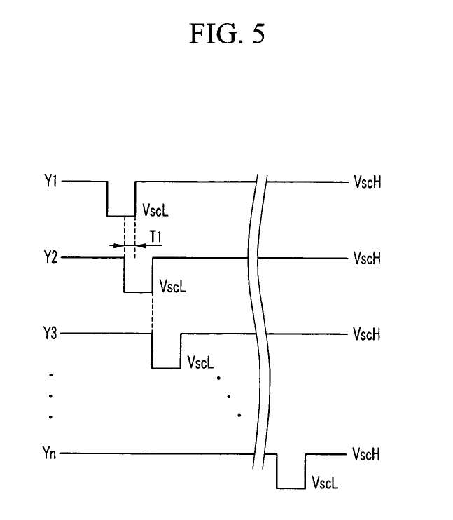

FIG. 3 is a block diagram illustrating a controller constructed as an exemplary embodiment of the present invention; FIG. 4 is a flowchart illustrating an operation of the controller constructed as an exemplary embodiment of the present invention; and FIG. 5 is a group of waveforms illustrating a group of driving waveforms of the plasma display device constructed as an exemplary embodiment of the present invention.

As shown in FIG. 3, controller 200 includes a screen load ratio calculator 210, a sustain discharge controller 220, a sustain discharge allocator 230, a subfield generator 240, a similarity ratio calculator 250, and a pulse controller 260.

Screen load ratio calculator 210 calculates a screen load ratio using image data input during one frame, in step S410. For example, screen load ratio calculator 210 may calculate the screen ratio from an average signal level of the image data during the one frame.

Sustain discharge controller 220 determines a total number of sustain pulses allocated to one frame according to the calculated screen load ratio, in step S420. In this case, sustain discharge controller 220 may store the total number of sustain pulses that is determined according to the screen load ratio in a look-up table, or may calculate the total number of sustain pulses by performing a logic operation on the data corresponding to the screen load ratio. In this case, when the number of light emitting cells is increased and the screen load ratio is increased, the total number of sustain pulses is decreased to prevent an increase in power consumption.

Sustain discharge allocator 230 allocates the total number of sustain pulses to each subfield (SF1-SF11 as shown in FIG. 2) in proportion to the weight values, in step S430.

Subfield generator 240 generates subfield data by using the image data input during one frame, in step 440. The subfield data indicates respective light emitting/non-light emitting states of the plurality of discharge cells 110 in the plurality of subfields (SF1-SF11 as shown in FIG. 2).

From the weights of each subfield of FIG. 2, image data of 120 grayscales may be generated to subfield data of “10011011010”. Here, “10011011010” respectively corresponds to the plurality of subfields SF1 to SF11, where “1” indicates that the discharge cell is light-emitted in a corresponding subfield, and “0” indicates that the discharge cell is not light-emitted in the subfield.

In step 450, similarity ratio calculator 250 compares values of subfield data corresponding to two discharge cells respectively disposed on two adjacent scan lines, and the two discharge cells disposed along of the address lines, and calculates data similarity ratio of the two adjacent scan lines by using a result of the comparison. That is, since the values of two bits corresponding to two discharge cells respectively defined by the two adjacent scan lines and disposed along the address line are “1” or “0”, the data similarity ratio may be calculated by a sum of a difference between values of the two bits corresponding to two discharge cells disposed on the two adjacent scan lines, as in Equation (1).

$$R \% = \frac{M - {\sum }_{i = 1}^{M} Δ {A}_{i}}{M} \times 100 \qquad ( 1 )$$

In Equation (1), ΔAᵢ denotes the difference between values of two bits of corresponding to the two discharge cells respectively disposed on the two adjacent scan lines and disposed along the i-th address line, and M is the total number of discharge cells in one of the two adjacent scan lines. For example, when it is assumed that there are 10 discharge cells disposed along one scan line, the value of the bit of each discharge cell in a scan line of a first row is “1, 0, 1, 0, 1, 0, 1, 0, 1, 0”, and the value of the bit of each discharge cell in a scan line of a second row is “1, 1, 1, 1, 1, 0, 1, 0, 1, 0”, since the number of bits having same value between the two adjacent discharge cells respectively defined by the adjacent scan lines and disposed along the i-th address line is 8 among the two rows of 10 discharge cells, the data similarity ratio is 80%. Here, “1, 0, 1, 0, 1, 0, 1, 0, 1, 0” and “1, 1, 1, 1, 1, 0, 1, 0, 1, 0” in order respectively denote the value of bits of each discharge corresponding to each A electrode (i.e., A1-A10).

Pulse controller 260 determines a degree of overlap of the scan pulses applied to the two corresponding scan lines according to the data similarity ratio, in step S460. That is, pulse controller 260 may determine the degree of overlaps so that the scan pulses respectively applied to the two corresponding scan lines are overlapped when the data similarity ratio is more than the predetermined ratio (i.e., 80%), and the scan pulses respectively applied to the corresponding two scan lines are not overlapped when the data similarity ratio is below the predetermined ratio.

Pulse controller 260 outputs an overlap control signal according to the degree of overlap to scan electrode driver 500, in step 470. Here, the overlap control signal may include a high level signal and a low level signal, one among the high level signal and the low level signal means that the scan pulses applied to the two corresponding scan lines are overlapped, and the other means that the scan pulses applied to the two corresponding scan lines are not overlapped. Hereinafter, the high level signal will be defined such that the scan pulses applied to the two corresponding scan lines are overlapped.

In detail, referring to FIG. 5, during the address period, in order to select the light emitting cell and the non-light emitting cell among the plurality of discharge cells within each subfield, scan electrode driver 500 sequentially applies the scan pulse having the voltage VscL to the Y electrodes Y1-Yn in a predetermined order. FIG. 5 shows that the scan pulse is sequentially applied to the Y electrode Y1-Yn. Here, scan electrode driver 500 sequentially receives the overlap control signal of the high level signal or the low level signal indicating degree of overlap of the scan pulses applied to the two adjacent Y electrodes from the Y electrode Y1 to the Y electrode Yn, and applies the scan pulses applied to the corresponding Y electrode to be overlapped with the scan pulse applied to the immediately previous Y electrode during a period T1 according to the overlap control signal.

That is, it is assumed that scan electrode driver 500 firstly receives the overlap control signal of the high level signal corresponding to the two adjacent Y electrodes Y1-Y2 and subsequently receives the overlap control signal of the low level signal corresponding to the two adjacent Y electrodes Y2-Y3. Then, as shown in FIG. 5, scan electrode driver 500 applies the scan pulse to the electrode Y2 to be overlapped with the scan pulse applied to the Y electrode Y1 during the period T1 according to the firstly received overlap control signal of the high level signal. Subsequently, scan electrode driver 500 applies the scan pulse to electrode Y3 to not be overlapped with the scan pulse applied to the Y electrode Y2 according to the subsequently received overlap control signal of the low level signal. Likewise, scan electrode driver 500 sequentially applies the scan pulse to the remaining Y electrodes according to the overlap control signal.

In this case, when the scan pulses applied to the two adjacent Y electrodes are overlapped, the address period may be reduced without reducing a width of the scan pulses. Further, luminance of an image may be improved when the reduced period is allocated to the sustain period.

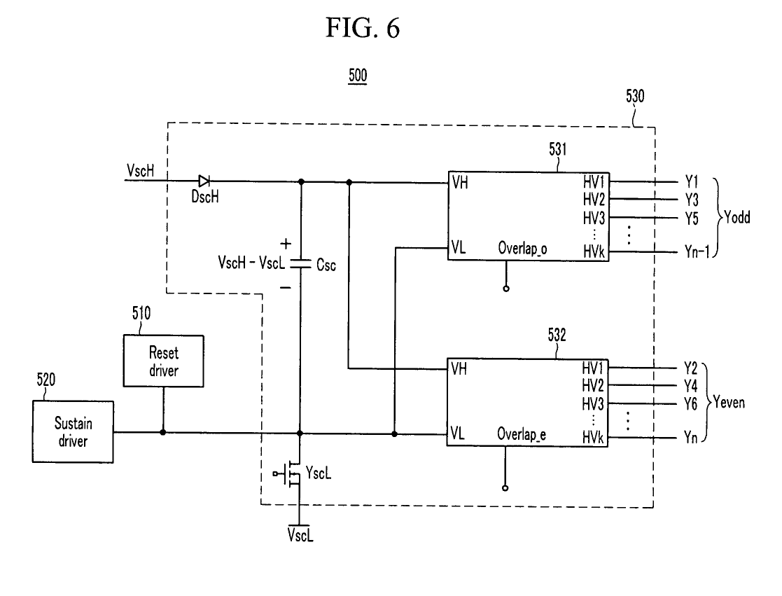

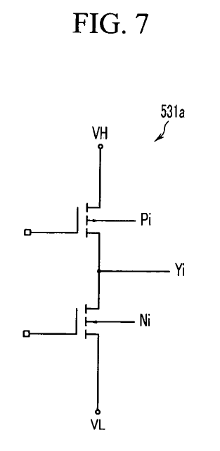

Next, a method for overlapping the scan pulses the scan pulses applied to the two adjacent Y electrodes will be described in detail with reference to FIGS. 6 and 7.

FIG. 6 is a schematic circuit diagram illustrating a scan electrode driver constructed as an exemplary embodiment of the present invention, and FIG. 7 is a schematic circuit diagram illustrating a schematic circuit of a pair of transistors included in the scan integrated circuit as shown in FIG. 6.

As shown in FIG. 6, scan electrode driver 500 includes a reset driver 510, a sustain driver 520, and a scan driver 530. Scan driver 530 includes scan integrated circuits (referred to as “scan ICs” hereinafter) 531 and 532, a capacitor Csc, a diode DscH, and a transistor YscL. In the exemplary embodiment of the present invention, the plurality of Y electrodes Y1 to Yn are grouped as two groups Yodd and Yeven. In this case, the first group Yodd includes odd-numbered Y electrodes among the plurality of Y electrodes, and the second group Yeven includes even-numbered Y electrodes among the plurality of Y electrodes. Scan ICs 531 and 532 respectively include a voltage terminal VH, a low voltage terminal VL, and a plurality of output terminals HV1-HVk. The plurality of output terminals HV1-HVk of scan IC 531 are respectively electrically connected to the Y electrodes of the first group Yodd. The plurality of output terminals HV1-HVk of scan IC 532 are respectively electrically connected to the Y electrodes of the second group Yeven.

It is assumed in FIG. 6 that n denotes an even number, and k is equal to n/2. A plurality of scan ICs may be used when the number of output terminals of scan ICs 531 and 532 is less than the number of Y electrodes of each group.

Further, scan ICs 531 and 532 respectively include pairs of transistors 531a. FIG. 7 shows only a pair of transistors 531a. Referring to FIG. 7, the pairs of transistors 531a include a PMOS transistor Pi connected between the high voltage terminal VH and an output terminal Yi and an NMOS transistor Ni connected between the low voltage terminal VL and the output terminal Yi, and a body diode is formed with the respective transistors Pi and Ni. At this time, when an input data is a low level, the transistor Pi is turned on, and thus a voltage of the high voltage terminal VH is outputted to the output terminal Yi. When the input data is a high level, the transistor Ni is turned on, and thus a voltage of the low voltage terminal VL is outputted to the output terminal Yi. The width of pulse corresponding to the input data is calculated according to the overlap control signals Overlap_o and Overlap_e. That is, during a predetermined period, a period in which the input data of the scan IC 531 is the low level may be overlapped with a period in which the input data of the scan IC 532 is the low level according to the overlap control signals Overlap_o and Overlap_e.

An anode of the diode DscH is connected to a power source VscH for supplying a VscH voltage, and a cathode of the diode DscH is connected to the high voltage terminal VH of scan ICs 531 and 532. A first terminal of the capacitor Csc is connected to the high voltage terminal of scan ICs 531 and 532, and the transistor YscL is connected between a power source for supplying the VscL voltage and the low voltage terminal of scan ICs 531 and 532. Since the transistor YscL is turned on during the address period, a voltage of (VscH-VscL) is charged in the capacitor Csc. Therefore, when a scan operation is performed to the first group Yodd, scan IC 531 sequentially applies the voltage of the low voltage terminal to the Y electrodes of the first group, and applies the voltage of the high voltage terminal to the Y electrode of the first group in which the voltage of the low voltage terminal is not applied. Scan IC 532 applies the voltage of the high voltage terminal to the Y electrode of the second group Yeven. When a scan operation is performed to the second group Yeven, scan IC 532 sequentially applies the voltage of the low voltage terminal to the Y electrodes of the second group Yeven, and applies the voltage of the high voltage terminal to the Y electrode of the second group Yeven in which the voltage of the low voltage terminal is not applied. Scan IC 531 applies the voltage of the high voltage terminal to the Y electrode of the first group Yeven.

Here, when the transistor Ni of scan ICs 531 and 532 are turned on, the voltage VscL may be outputted through to the output terminal Yi, and when the transistor Pi of scan ICs 531 and 532 are turned on, the voltage VscH may be outputted through to the output terminal Yi.

Meanwhile, the exemplary embodiment of the present invention has described that controller 200 determines the degree of overlap of the scan pulses applied corresponding to two scan lines according to the data similarity ratio.

Since the number of light emitting cells is reduced in the subfield having a low weight value among the plurality of subfields, however, the probability that the data similarity ratio is more than the predetermined ratio is reduced. Further, since the number of light emitting cells increases in the subfield having a high weight value among the plurality of subfields, the probability that the data similarity ratio is more than the predetermined ratio is increased. Thus, controller 200 may determine the degree of overlap so that the scan pulses applied to the two scan lines are overlapped in only the subfields having the high weight values (i.e., the subfields SF9 through SF11 in FIG. 2), and the scan pulses applied to the two scan lines are not overlapped in the subfields having the low weight values (i.e., the subfields SF1 to SF8 in FIG. 2).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device, comprising:
a plurality of scan lines for selecting a plurality of discharge cells and the plurality of scan lines extending in a row direction;
a driver electrically coupled to sequentially applying a scan pulse to the plurality of scan lines during an address period;
a controller for dividing one frame into a plurality of subfields with each including an address period, determining a degree of overlap between the scan pulses applied to two adjacent scan lines according to a data similarity ratio of the two adjacent scan lines among the plurality of scan lines by using image data input during the one frame, and outputting an overlap control signal according to the degree of overlap to the driver; and
the driver determining whether overlaps or does not overlap, in a time scale, the scan pulses applied to the two adjacent scan lines in accordance with the output overlap control signal.

2. The plasma display device of claim 1, with
the overlap control signal including a first level signal and a second level signal,
the driver overlapping the scan pulses applied to the two adjacent scan lines during a predetermined period according to the first level signal, and not overlapping the scan pulses applied to the two adjacent scan lines according to the second level signal, and
the controller outputting the first level signal to the driver when the data similarity ratio is greater than a predetermined ratio.

3. The plasma display device of claim 2, with the controller further comprising:
a subfield generator for generating subfield data indicating light emitting and non-light emitting states of the respective plurality of discharge cells using image data; and
a similarity ratio calculator for calculating the data similarity ratio by using the subfield data of each discharge cell disposed on the two adjacent scan lines, with each bit of the subfield data corresponding to each subfield of the plurality of subfields.

4. The plasma display device of claim 3, with the similarity ratio calculator calculating the data similarity ratio by using a sum of a difference between values of the subfield data of two adjacent discharge cells respectively disposed on two adjacent scan lines, and the two adjacent discharge cells disposed along one of a plurality of address lines.

5. The plasma display device of claim 4, with the plurality of address lines being formed to respectively correspond to the plurality of discharge cells in a column direction, and the driver selectively applying address pulses to the plurality of address lines according to the subfield data when the scan pulse is sequentially applied to the plurality of scan lines during the address period.

6. A method for driving a plasma display, the method comprising:
dividing a frame into a plurality of subfields;
generating, by using input image data, subfield data indicating light emitting and non-light emitting states of respective discharge cells of the plasma display device which includes a plurality of scan lines for selecting a plurality of discharge cells and sequentially applies a scan pulse to the plurality of scan lines;
respectively calculating a data similarity ratio of two adjacent scan lines among the plurality of scan lines by using the subfield data;
determining a degree of overlap of the scan pulses applied to the two adjacent scan lines according to the calculated data similarity ratio; and
selectively overlapping the scan pulses applied to the two adjacent scan lines according to the determined degree of overlap.

7. The method of claim 6, the step of the determining of the degree of overlap further comprising the steps of:
overlapping the scan pulses during a period of a part when the data similarity ratio is greater than a predetermined ratio; and
not overlapping the scan pulses when the data similarity ratio is below the predetermined ratio.

8. The method of claim 6, with the data similarity ratio being calculated by using a sum of a difference between values of the subfield data of two adjacent discharge cells respectively disposed on two adjacent scan lines, and the two adjacent discharge cells disposed along one of a plurality of address lines.

9. A method of driving a plasma display device, the method comprising:
in an address period, sequentially outputting an overlap control signal according to a data similarity ratio of two adjacent scan lines among a plurality of scan lines of the plasma display device which includes the plurality of scan electrodes and a plurality of address electrodes crossing the plurality of scan electrodes, and a plurality of discharge cells formed by the plurality of scan electrodes and the plurality of address electrodes; and
sequentially applying a scan pulse to the plurality of scan lines in accordance with the overlap control signal,
with the overlap control signal including a first level signal and a second level signal, and
with the scan pulses applied to the two adjacent scan lines being overlapped according to the first level signal, and the scan pulses applied to the two adjacent scan lines being not overlapped according to the second level signal.

10. The method of claim 9, further comprising:
selectively applying address pulses to the plurality of address lines according to the subfield data when the scan pulse is sequentially applied to the plurality of scan lines during the address period, with the subfield data indicating light emitting and non-light emitting states of the respective plurality of discharge cells, and with the data similarity ratio being calculated using the subfield data of each discharge defined by the two adjacent scan lines.

11. The method of claim 9, with the step of sequentially outputting of the overlap control signal further comprising the steps of:
outputting the first level signal when the data similarity ratio is more than a predetermined ratio; and
outputting the second level signal when the data similarity ratio is below the predetermined ratio.

12. A plasma display device driven by dividing a frame into a plurality of subfields each having a weight value, the plasma display device comprising:
a plurality of scan lines for selecting a plurality of discharge cells and the plurality of scan lines extending in a row direction;
a driver electrically coupled to sequentially applying a scan pulse to the plurality of scan lines during an address period; and
a controller for controlling the driver so that scan pulses respectively applied to adjacent first and second scan lines among the plurality of subfields are overlapped in a first subfield among the plurality of subfields, and the scan pulses respectively applied to the adjacent first and second scan lines are not overlapped in a second subfield among the plurality of subfields, with a weight value of the first subfield being greater than a weight value of the second subfield.

13. The plasma display device of claim 12, with a data similarity ratio of the first and second scan lines being greater than a predetermined ratio in the first subfield.

14. The plasma display device of claim 13, with
the controller generating subfield data of first row of discharge cells disposed on the first scan line and subfield data of second row of discharge cells disposed on the second scan line, and calculating the data similarity ratio by using a sum of a difference between values of the subfield data of the first and second rows of discharge cells, and
each bit of the subfield data corresponding to each subfield of the plurality of subfields.

15. A plasma display device, comprising:
a plurality of scan lines and a plurality of address lines for selecting a plurality of discharge cells of the plasma display device, with the plurality of scan lines extending in a first direction and the plurality of address lines extending in a second direction;
a driver electrically coupled to sequentially apply a scan pulse to the plurality of scan lines during an address period;
a controller dividing one frame into a plurality of subfields with each including an address period, determining a degree of overlap in a time scale between the scan pulses applied to two adjacent scan lines according to a data similarity ratio of the two adjacent scan lines among the plurality of scan lines by using image data input during the one frame, and outputting an overlap control signal according to the degree of overlap to the driver; and
the driver comprising first and second scan integrated circuits with each of the first and second integrated circuits comprising one input port for receiving the overlap control signal, one data port for receiving the data similarity ratio, one PMOS transistor with a first terminal electrically connected to the data port and a second terminal electrically connected to a first electrical potential, and one NMOS transistor with a fourth terminal electrically connected to the data port, a fifth terminal electrically connected to a second electrical potential and a sixth port electrically connected to a third terminal of the PMOS transistor; and the driver overlapping or not overlapping, in the time scale, the scan pulses applied to the two adjacent scan lines according to the overlap control signal.

16. The plasma display device of claim 15, with one of the first and second integrated circuits providing the scan pulse to the even numbered plurality of scan electrodes and another of the first and second integrated circuits providing the scan pulse to the odd numbered plurality of scan electrodes.
